(19) United States
(12) Patent Application Publication
(10) Pub. No.: US 2009/0200721 A1
(43) Pub. Date: Aug. 13, 2009

(54) Motor vehicle spring comprising fiber composite material

(76) Inventors: Vladimir Kobelev, Attendorn (DE); Karsten Westerhoff, (US); Jorg Neubrand, Freudenberg (DE); Robert Brandt, Attendorn (DE); Jorg Dieter Brecht, Olpe (DE)

Correspondence Address: WYATT, GERBER & O'ROURKE, 99 PARK AVENUE, NEW YORK, NY, 10016, US

(21) Appl. No.: 12/321,980

(22) Filed: Jan. 28, 2009

(30) Foreign Application Priority Data
Jan. 28, 2008 (DE) 102008006411.4-12

(51) Int. Cl. F16F 1/02

(52) U.S. Cl. 267/195

(57) ABSTRACT

A band spring including fiber composite material and extending in an undulating way, wherein a spring band can be provided to meander in the form of one single wave train composed of reversal regions and intermediate portions around a longitudinal center line L which can substantially correspond to the direction of force introduction K, and wherein, there can be provided an increased resistance moment of the spring band in the reversal regions of the wave train.

### SUMMARY

The invention relates to a band spring comprising a fiber composite material extending in an undulating way, wherein a spring band meanders in the form of one single wave train having reversal regions and intermediate portions around a longitudinal center line L which, substantially, corresponds to the direction of a force being introduced K.

Furthermore, the invention relates to a band spring comprising a fiber composite material and extending in a double wave form, wherein two spring bands meander in the form of wave trains having reversal regions and intermediate portions around two center lines L1, L2 which extend parallel relative to one another and which are positioned parallel to a longitudinal center line L which is positioned therebetween and which substantially corresponds to the direction of a force being introduced K.

### BACKGROUND

Products comprising fiber composite materials can be produced from mattings of resin-impregnated woven fabrics or fiber mattings (prepregs) in certain pre-cut shapes or of resin-impregnated fiber bundles whose fibers can extend in parallel or are twisted inside one another (rowings), which mattings or bundles can be placed into moulds and brought pressure-loaded to an increased temperature, wherein the resin forming of the matrix can be irreversibly hardened.

Such mattings can be positioned one above the other in multiple layers, and different matting qualities can also be provided. Fiber strands can be woven or twisted relative to one another, so that fabric-like structures can be obtained. The fibers can include glass fibers, carbon fibers, aramid fibers (Kevlar) or even metal fibers, either on their own or mixed. Typically, the resins used can harden irreversibly at temperatures of 150 to 180° C. and provide the finished product with its permanent shape.

In U.S. Pat. No. 4,927,124 A and U.S. Pat. No. 5,013,013 A band springs of a first type are described. For example, a band spring can be comprised of a substantially constant width and constant thickness along the entire length of the spring. In addition, two band springs of such type can be used in a symmetric arrangement in a spring strut for a motor vehicle.

In DE 199 62 026 A1 band springs of a second type are described and which are connected to one another in pairs. The wave trains of the two spring bands are positioned at a distance from one another and parallel relative to one another, and wherein only the respective end regions are connected to one another. In this case, the band spring is proposed for use in the spring strut of a motor vehicle.

US 2007/0267792 proposes band springs having a constant width wherein the thickness of first reversal regions is increased relative to that of second reversal regions and connecting intermediate portions. Compression is effected through deformation of the respective second reversal regions having thinner material and which, can be subjected to disadvantageously high loads as a consequence. It is proposed to use two band springs of this type in a damper unit in a motor vehicle.

### OBJECTS OF THE INVENTION

It is an object of the present invention to provide band springs which comprise advantageous load bearing characteristics when in use and thus promise a longer service life. In addition, the use of such springs in spring struts provide for a new compact design.

A first embodiment of a device according to the invention includes providing a band spring having a fiber composite material and extending in an undulating way. The spring band can be provided to meander in the form of one single wave train having reversal regions and intermediate portions around a longitudinal center line L which can substantially correspond to the direction of a force being introduced K, and wherein an increased resistance moment of the spring band can be provided in the reversal regions of the wave train. The resistance moment W can be calculated using the width B and the thickness H of the spring band according to formula W=(B×H²):12.

When the spring is subjected to loads, a device according to the invention provides increased resistance moment in the reversal regions which can provide for reduced stresses in the reversal regions, thus avoiding delamination in these critical regions which can result from shear stresses in the material, with delamination meaning at least local loosening of the bonding between the fiber material and the matrix. In such a load-bearing spring largely uniform stress conditions typically prevail, and thus optimum material utilisation can provide for minimal weight, which is a further benefit for the spring according to the invention which also has a very compact shape.

A second embodiment of a device according to the invention includes providing a band spring having a fiber composite material and extending in a doubly undulating way. The two spring bands can be provided to meander in the form of waves trains having reversal regions and intermediate portions around two center lines L1, L2. These lines can extend parallel relative to one another and can be positioned parallel to a longitudinal center line L, which can be positioned between the two center lines and which can substantially corresponds to the direction of a force being introduced K. The spring bands can be connected to one another in first inner reversal regions of the wave trains and provides an increased resistance moment in the second outer reversal regions of the wave trains. The resistance moment W can be calculated using the width B and the thickness H of the spring band in accordance with formula W=(B×H²):12.

When such a spring is subjected to loads, the stresses in the material especially can be reduced due to the increased resistance moment, and thus provide the effects and benefits as described above. As compared to double band spring arrangements according to the state of the art, the inventive arrangement is much more compact.

The resistance moment in the reversal regions of the single-wave spring and in the outer reversal regions of the double-wave spring can be increased by increasing the thickness H of the spring band in either or both of those regions. In addition, or in the alternative, the width B can remain constant or be reduced.

According to a preferred embodiment, the cross-section of the spring band or spring bands respectively can be provided to be substantially constant along the entire band length. In this case, the resistance moment in the reversal regions can be increased by increasing the thickness H, which can be reflected in a calculation of the resistance moment with a higher power than the width B.

The resistance moment in the reversal regions can also be increased, optionally even with substantially constant cross-sectional areas. For example, fiber materials can be provided in the reversal regions. In addition, or in the alternative, additional layers of prepregs or additional windings of rowings can be provided extending transversely to the longitudinal extension of the spring band.

Both the variation in the width of the spring band and the variation in the thickness of the spring band is preferable provided to be substantially continuous or finely stepped. The variation in the width can be provided through modifying the shape of the cut of the prepregs. In addition, the variation in the thickness can be effected by providing portions having larger numbers of prepreg layers.

Additional advantages of material utilisation and cost reduction, can be achieved in an embodiment of a band spring, according to the invention having several layers, with a central layer comprising prepregs of a lower quality, such as glass-fiber-reinforced resin-impregnated material, and outer layers comprising prepregs of a higher quality, such as a carbon-fiber-reinforced or aramid-fiber-reinforced resin-impregnated material.

In an embodiment of a double-wave spring, suitable laying techniques or winding techniques can be applied so that the resin-impregnated fiber material in the inner reversal regions runs in an uncut condition from the spring band of the one wave train into the spring band of the other wave train, with regular intersections leading to a firm compound. With this type of solution, it is preferred to produce the fiber composite member from fiber strands laid in situ, and which are provided to be entangled with one another. The fiber strands can extend at small angles relative to the longitudinal direction of the spring bands while intersecting one another regularly.

Intermediate products formed of prepregs and/or rowings can be placed into heatable moulds for finishing and can be hardened under pressure. Embodiments of band springs, such as for use in spring struts, can comprise through-holes which can be aligned in the direction of the longitudinal center line and through which it is possible to pass a damper assembly. The through-holes are preferably produced during the production of the band springs by cutting the prepregs accordingly and/or by laying the rowings accordingly. However, they can also be drilled after production.

The band springs can be provided to terminate at each end in a reversal region. In this way, the last intermediate portion can be provided to form a large supporting face which can be placed onto a spring plate having an adapted shape.

### BRIEF DESCRIPTION OF THE DRAWINGS

FIG. 1 illustrates a three-dimensional view of a first embodiment of a band spring according to the invention having a single-wave.

FIG. 2 illustrates a three-dimensional view of a second embodiment of a band spring according to the invention having a single-wave.

FIG. 3 illustrates a three-dimensional view of a third embodiment of a band spring according to the invention having a single-wave.

FIG. 4 illustrates a three-dimensional view of a fourth embodiment of a band spring according to the invention having a single-wave.

FIG. 5 illustrates a three-dimensional view of a fifth embodiment of a band spring according to the invention having a single-wave.

FIG. 6 illustrates a three-dimensional view of a sixth embodiment of a band spring according to the invention having a single-wave.

FIG. 7 illustrates the band spring according to FIG. 6 having a spring strut.

FIG. 8 Illustrates a three-dimensional view of a seventh embodiment of a band spring according to the invention having a single-wave.

FIG. 9 illustrates the band spring according to FIG. 8 having a spring strut.

FIG. 10 illustrates a three-dimensional view of an eighth embodiment of a band spring according to the invention having a single-wave.

FIG. 11 illustrates the band spring according to FIG. 10 having a spring strut in an exploded view.

FIG. 12 illustrates a spring strut according to FIG. 11 in a finish-mounted position.

FIG. 13 illustrates a three-dimensional view of an embodiment of band spring according to the invention, having two-waves.

FIG. 14 illustrates a spring strut having a band spring according to FIG. 7.

FIG. 15 illustrates design aspects of a band spring according to the invention having a straight longitudinal center line L

a) in an untensioned condition, and

b) as clamped in between parallel spring supports.

FIG. 16 illustrates design aspects of a band spring according to the invention having a C-shaped curved longitudinal center line L

a) in an untensioned condition, and

b) as clamped in between parallel spring supports.

FIG. 17 illustrates design aspects of a band spring according to the invention having an S-shaped curved longitudinal center line L

a) in an untensioned condition, and

b) as clamped in between parallel spring supports.

FIG. 18 illustrates design aspects of a band spring according to the invention having a curved longitudinal center line L obtained by superimposing a C-shape and an S-shape

a) in an untensioned condition, and

b) as clamped in between two parallel spring supports.

### DETAILED DESCRIPTION OF THE INVENTION

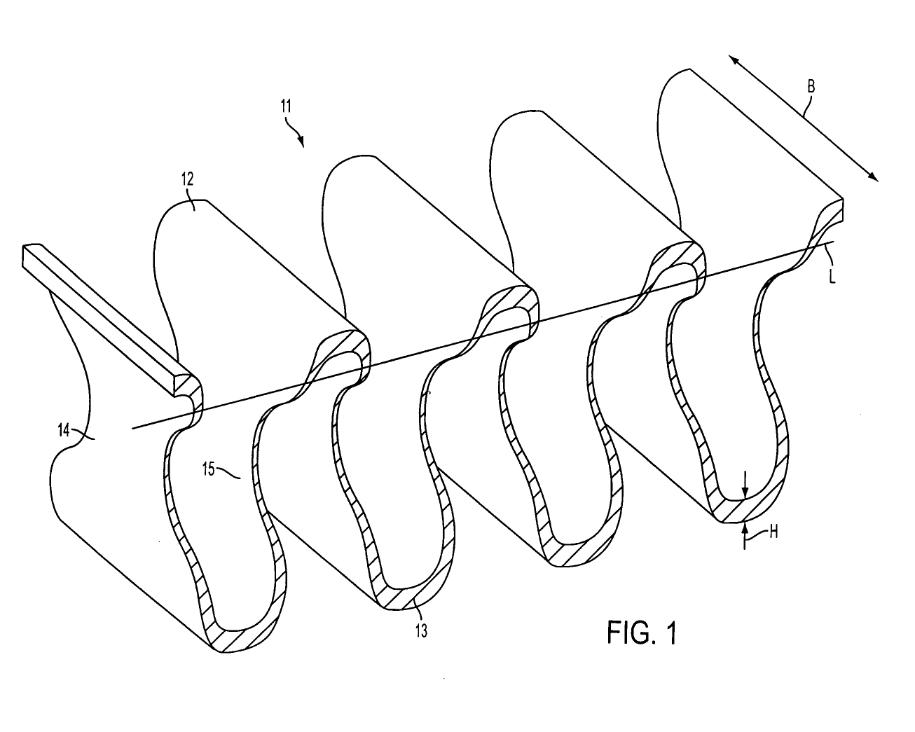

FIG. 1 shows an inventive band spring 11 in a first embodiment which comprises a wave-shaped spring band, and which can be provided to meander around a longitudinal center line L to form four complete wave units. Three complete first reversal regions 12, and two halves of first reversal region 12, are provided. In addition, four complete second reversal regions 13, with the two halves of reversal regions are also provided, defining the ends of the band spring 11. The more strongly curved reversal regions 12, 13 can be connected by intermediate regions 14, 15 having a less pronounced curvature. In the present embodiment, the material thickness of the spring band can be variable, and the thickness H and the spring band width B, which extends transversely to the wave line, can be provided to be much greater in the reversal regions 12, 13 than in the connecting regions 14, 15. The changes in width can be provided to be at a constant rate, and can be provided in a form represented by a sine curve of the edge lines (by viewing the spring band in one plane). If tensile and compressive forces are introduced into the respective outer intermediate portions 14, 15 and into the halves of the reversal regions 12 at the ends of the band spring, the band spring can become shortened and lengthened. Because of the increase in thickness and width, the resistance bending moments of the reversal regions 12, 13 may become considerably greater than in the intermediate portions 14, 15. In this way, it is an advantage of the invention to provide more uniform stress conditions in the material of the band springs along their entire length.

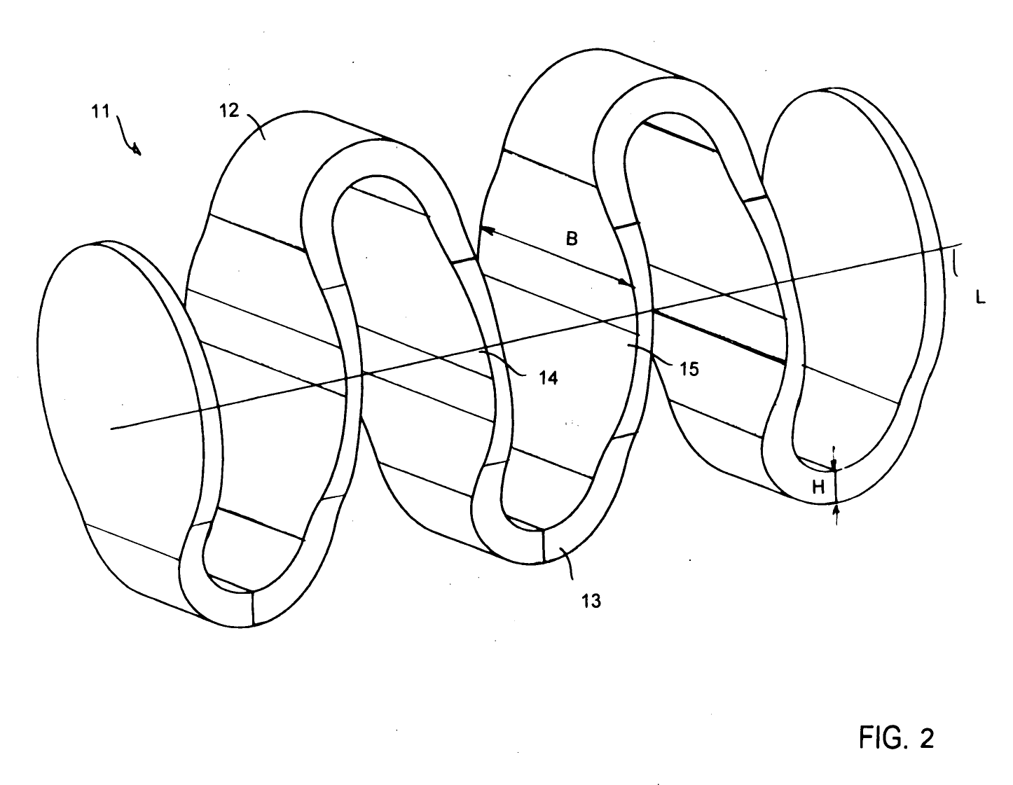

FIG. 2 shows an inventive band spring 11 in a second embodiment which comprises a wave-shaped spring band and which can be provided to meander around a longitudinal center line L to form two complete wave units. Two complete first reversal regions 12, and three complete second reversal regions 13 are provided. In addition, the ends of the band spring 11 can be provided so that they do not form reversal regions. The more strongly curved reversal regions 12, 13 can be connected by intermediate portions 14, 15 with a lesser curvature. In the present embodiment, the material thickness of the spring band can be variable, and the thickness H in the reversal regions 12, 13 can be provided to be greater. The width B of the band string in the reversal regions 12, 13, which width B extends transversely to the wave line, can be provided to be smaller than in the connecting regions 14, 15. The changes in width can be provided to be at a constant rate and can be provided in a form represented by a sine curve of the edge lines (by viewing the spring band in one plane). If tensile and compressive forces are introduced into the respective outer intermediate portions 14, 15 at the ends of the band spring, the band spring is shortened and lengthened. Because of the increase in thickness, the resistance bending moments of the reversal regions 12, 13 may become considerably greater than in the intermediate portions 14, 15. In this way, it is an advantage of the invention to provide more uniform stress conditions in the material of the band springs along their entire length.

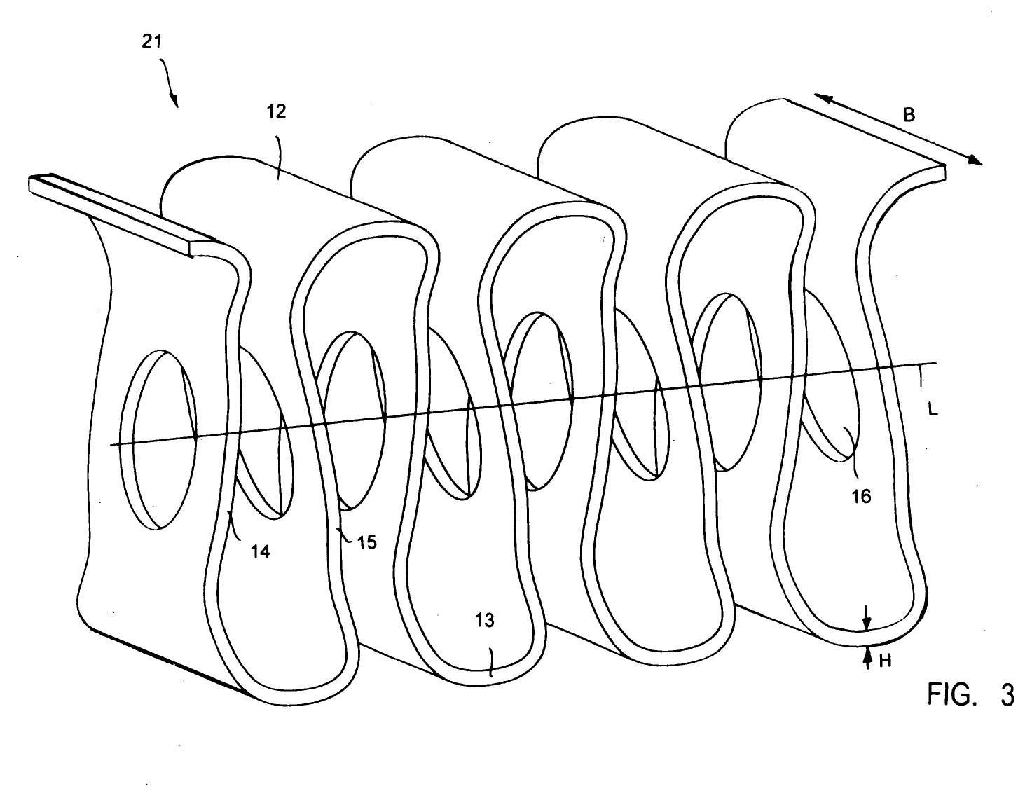

FIG. 3 shows a band spring 21 in a third embodiment. Identical details have been given the same reference numbers in as the case of the band spring according to FIG. 1. To that extent, reference is made to the preceding description. The band spring 21 shown here comprises one spring band which can be provided to meander around a longitudinal center line L to form a total of four complete wave units. The thickness H of the spring band can be constant, and the width B of the spring band can be provided to vary. The reversal regions 12, 13 can be provided to have a greater width relative to the intermediate portions 14, 15. Among other things, FIG. 3 deviates from FIG. 1, in that the intermediate portions 14, 15 can comprise holes 16 whose centers (not especially marked) can be positioned on the longitudinal center line L and whose sizes can correspond to one another, so that, if viewed in the direction of the longitudinal center line L, the holes 16 can be aligned relative to one another. It can be appreciated that the holes 16 can be round or ellipsoidal.

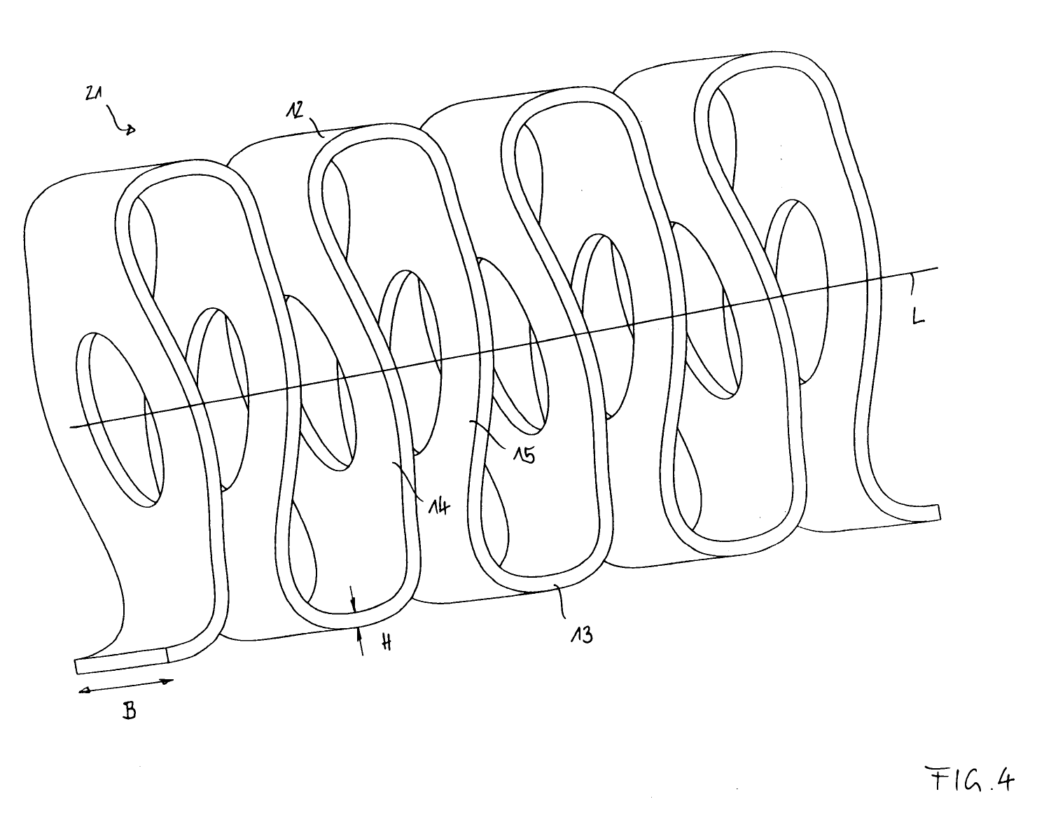

FIG. 4 shows a band spring 21 in a fourth embodiment. Identical details have been given the same reference numbers in as the case of the band spring according to FIG. 1. To that extent, reference is made to the preceding description. The band spring 21 shown here also comprises one spring band which can be provided to meander around a longitudinal center line L to form a total of four complete wave units. The thickness H of the spring band can be constant, and the width B of the spring band can be provided to vary with the reversal regions 12, 13 comprising a smaller width relative to the intermediate portions 14, 15. As in this case, too, the intermediate portions 14, 15 can be provided with holes. In addition, the effective cross-sectional area of the spring band in the reversal regions 12, 13 can be provided to be greater than in the intermediate portions. If viewed in the direction of the longitudinal center line L, the holes 16 can be aligned relative to one another. In addition, the holes 16 can be provided to be round or ellipsoidal.

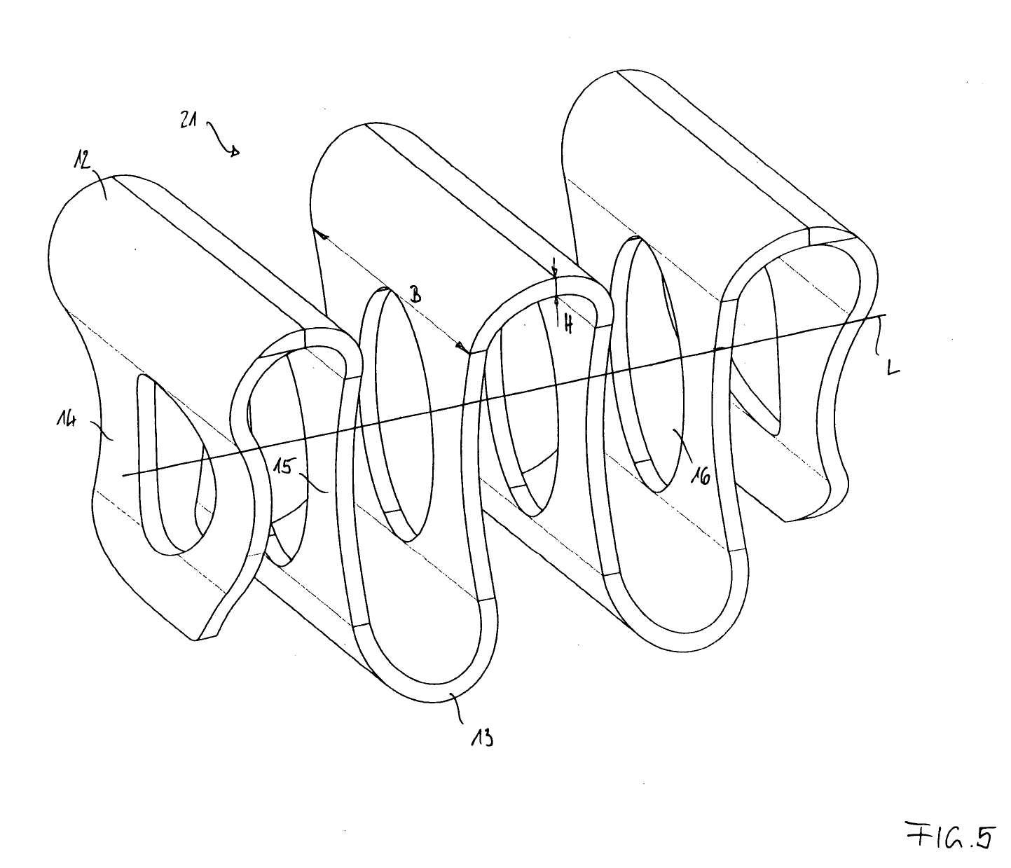

FIG. 5 shows a band spring 21 in a fifth embodiment. Identical details have been given the same reference numbers in as the case of the band spring according to FIG. 1. To that extent, reference is made to the preceding description. The band spring 21 shown here also comprises one spring band which can be provided to meander around a longitudinal center line L to form two complete wave units. Again, the thickness H of the spring band can be constant, and the width B of the spring band can be provided to vary. The reversal regions 12, 13 can be provided to have a larger width relative to the intermediate portions 14, 15. Among other things, FIG. 5 deviates from FIG. 1 in that the intermediate portions 14, 15 can each be provided with holes 16 whose centers (not especially marked) can be positioned on the longitudinal center line L and can be provided with corresponding sizes, so that, if viewed in the direction of the longitudinal center line L, the holes 16 can be aligned relative to one another. It can be appreciated that the holes 16 can be round or ellipsoidal.

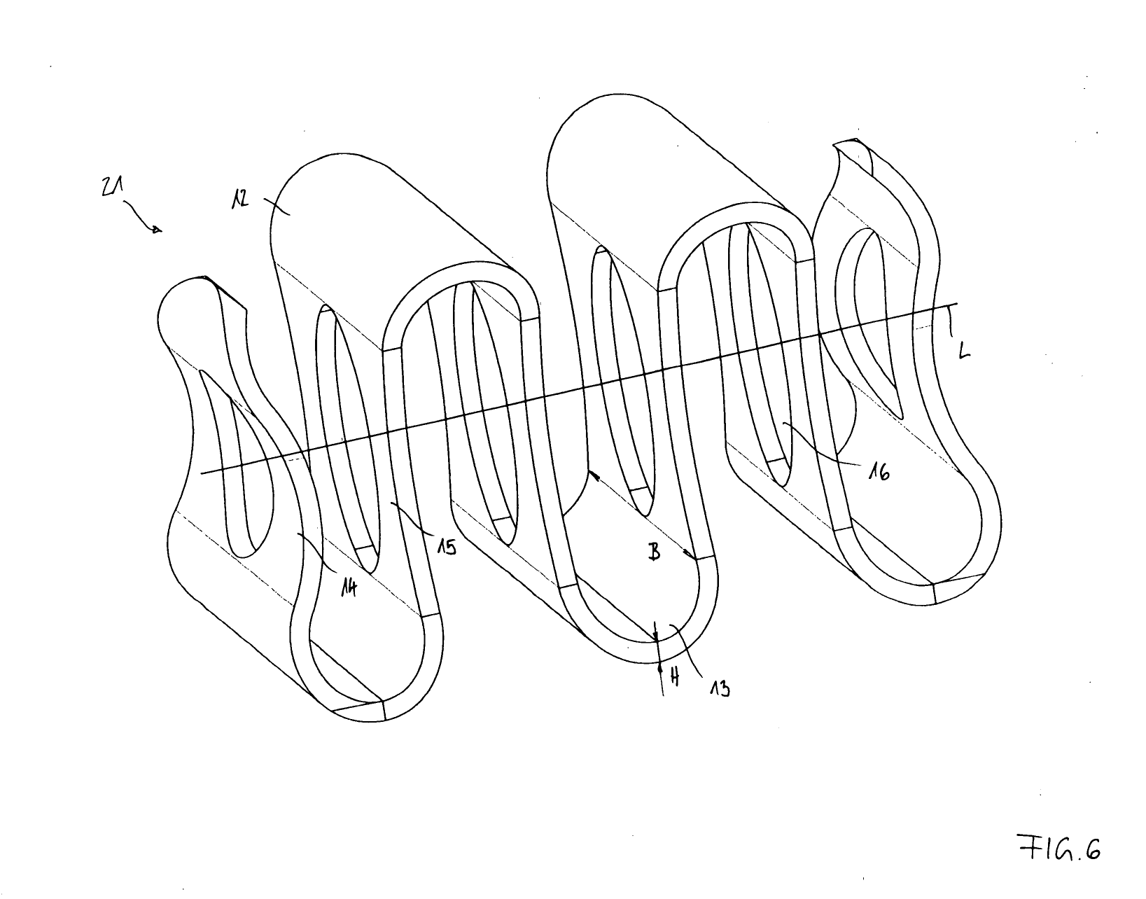

FIG. 6 shows a band spring 21 in a sixth embodiment. Identical details have been given the same reference numbers as in the case of the band spring according to FIG. 1. To that extent, reference is made to the preceding description. The band spring 21 shown here also comprises one spring band which can be provided to meander around a longitudinal center line L to form two complete wave units. Again, the thickness H of the spring band can be constant, and the width B of the spring band can be provided to vary. The reversal regions 12, 13 can be provided to have a larger width relative to the intermediate portions 14, 15. Among other things, FIG. 5 deviates from FIG. 1 in that the intermediate portions 14, 15 can each be provided with holes 16 whose centers (not especially marked) can be positioned on the longitudinal center line L and can be provided with corresponding sizes, so that, if viewed in the direction of the longitudinal center line L, the holes 16 can be aligned relative to one another. It can be appreciated that the holes 16 can be round or ellipsoidal.

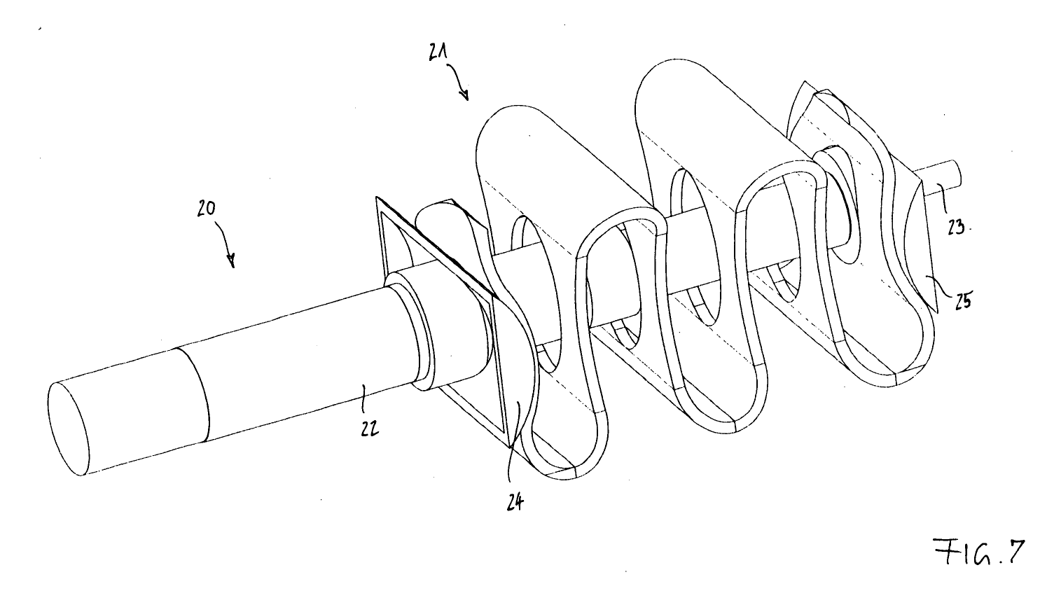

In FIG. 7, a damper unit 20 for a spring strut is mounted on a band spring 21 according to the invention, such as that shown in FIG. 6. An outer damper tube 22 is firmly connected to a first spring plate 24 and an inner damper tube 23 is firmly connected to a second spring plate 25. The damper unit 20 passes through the holes 16 of the intermediate portions 14, 15. The upper and lower spring plates 24, 25 can be dish-shaped plate-metal structures which can rest in a planar way on the end intermediate portions 14, 15 of the wave train of the band spring 21. The supported intermediate portions can be disposed so that they are not being subjected to bending loads. To that extent, the variations in the width and thickness of the spring in the supported regions can be less important. However, the last of the complete reversal regions 12, 13, which project from the spring plates 24, 25 can be provided with an increased bending moment resistance. It can be appreciated that the damper unit 20 can also guide the spring band, and can prevent lateral buckling in either the central plane of the wave train or in the vertical central plane because the holes 16 can be guided on the damper unit 20.

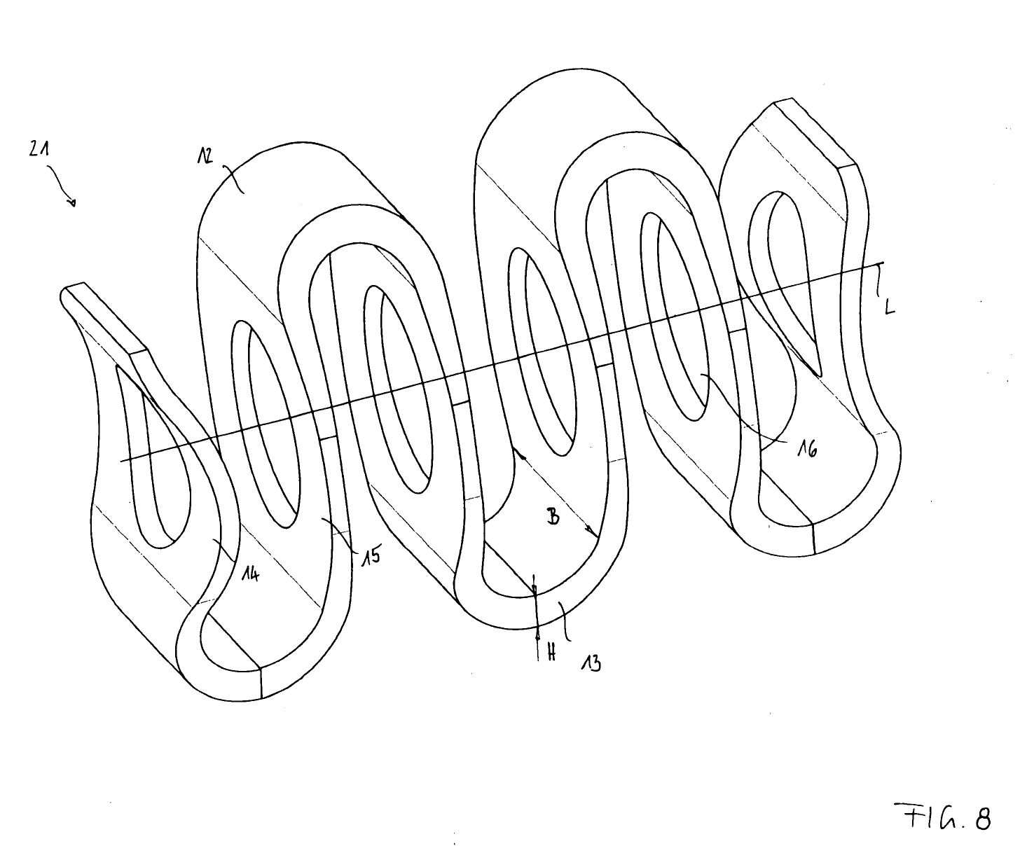

FIG. 8 shows a band spring 21 in a seventh embodiment. Identical details have been given the same reference numbers in as the case of the band spring according to FIG. 1. To that extent, reference is made to the preceding description. The band spring 21 shown here also comprises one spring band which can be provided to meander around a longitudinal center line L to form two complete wave units. The thickness H of the spring band can be provided to vary and the width B of the spring band can also be provided to vary. The reversal regions 12, 13 can be provided to have a greater thickness H and smaller width B as compared to corresponding dimensions of the intermediate portions 14, 15. Among other things, FIG. 8 deviates from FIG. 1 in that the intermediate portions 14, 15 are each provided with holes 16 whose centers (not especially marked) can be positioned on the longitudinal center line L and be provided with corresponding sizes, so that, if viewed in the direction of the longitudinal center line L, the holes 16 can be aligned relative to one another. It can be appreciated that the holes 16 can be round or ellipsoidal.

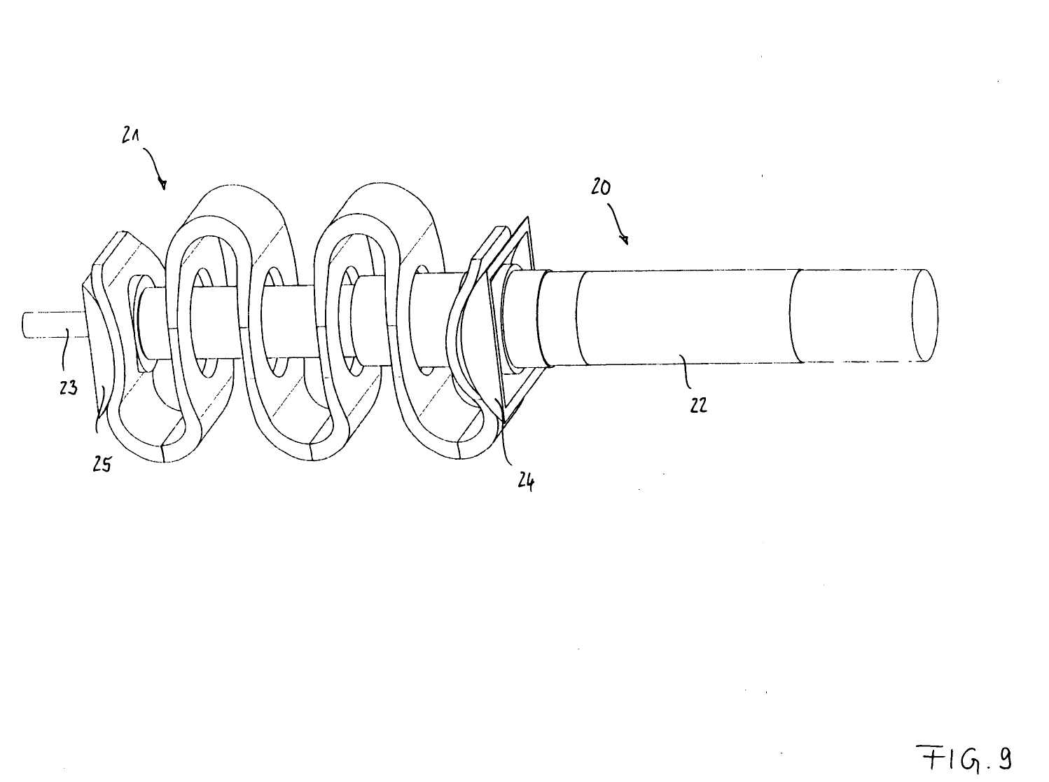

In FIG. 9, a damper unit 20 for a spring strut is mounted on an inventive band spring 21 according to the invention. An outer damper tube 22 is firmly connected to a first spring plate 24 and an inner damper tube 23 is firmly connected to a second spring plate 25. The damper unit 20 passes through the holes 16 of the intermediate portions 14, and the upper and lower spring plates 24, 25 can be dish-shaped plate-metal structures which can be provided to rest in a planar way on the end intermediate portions 14, 15 of the wave train of the band spring 21. The supported intermediate portions can be disposed so that they are not being subjected to bending loads. To that extent, the variations in the width and thickness of the spring band in the supported regions can be less important. However, the last of the complete reversal regions 12, 13, which project from the spring plates 24, 25, can be in accordance with the invention, already have to be provided with an increased bending moment resistance. It can be appreciated that the damper unit 20 can also guide the spring band, and can prevent lateral buckling in either the central plane of the wave train or in the vertical central plane because the holes 16 can be guided on the damper unit 20.

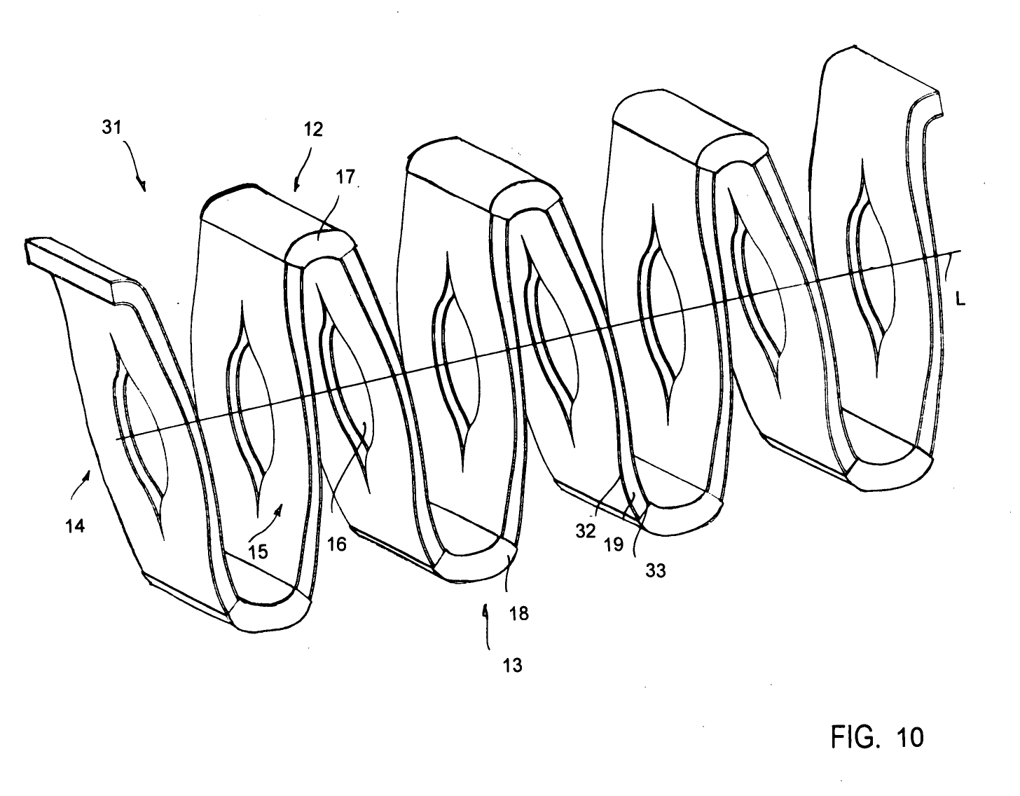

FIG. 10 shows a band spring 31 according to the invention in an eighth embodiment which comprises an undular spring band which, can be provided to meander around a longitudinal center line L and form four complete wave units. Four complete first reversal regions 12, and three complete second reversal regions 13 are provided. In addition, two halves of second reversal regions 13 can be provided with the halves of the reversal regions defining the ends of the band spring 31. The more strongly curved reversal regions 12, 13 can be provided connected by intermediate portions 14, 15 which can be provided with lesser curvature. In the present embodiment, the material thickness of the spring band can be provided to be variable, and the thickness H of the band spring in the reversal regions 12, 13 can be provided to be greater than in the connecting regions 14, 15. The changes in thickness can be provided to be approximately constant. When tensile and compressive forces are introduced into the respective outer connecting regions 14, 15 and into the halves of the reversal regions 13 at the end of the band spring, the band spring is shortened and lengthened. Because of the increase in thickness, the bending resistance moments in the reversal regions 12, 13 can be provided to be greater than in the intermediate regions 14, 15. In this way, improved most uniform stress conditions in the material of the band spring can be provided. Among other things, the Figure deviates from the band springs according to the preceding Figure in that the effective width of the spring band can be provided to vary less in this embodiment. In accordance with the embodiments according to FIGS. 2 and 3, the band spring shown here can also be provided with holes 16′ whose centers (not given any reference numbers) can be positioned on the longitudinal center line L, so that, if viewed in the direction of the longitudinal center line L, the holes are aligned relative to one another. The holes 16′ can be provided to deviate from those described previously in that they can be lens-shaped, with longitudinal lengthening taking place in the direction of the longitudinal extension of the spring band. In this case, the material width of the two parts of the intermediate portions 14, 15 in the region of the holes 16′ can be approximately constant, with the bulges of the intermediate portions resulting from the lens shape of the holes 16′.

In embodiments of the invention, variation in the thickness of the spring band can be provided by, among other things, placing additional prepregs onto the reversal regions 12, 13. Additional prepregs can be provided so that, unlike the base prepregs, they do not extend along the whole length of the undulating spring band.

In embodiments of the invention, both the first reversal regions 12 and also the second reversal regions 13 can be additionally provided with wound portions 17, 18 which are intended to show fiber windings which can be provided, in the form of reinforcing windings, and which can be applied to the reversal regions 12, 13 prior to or after the production of the wave train. Only the halves of reversal regions at the ends of the band spring are not provided with fiber windings.

In a further embodiment, a band spring 31 can be provided having a layered structure which can include a central layer 19 having a variable thickness produced from prepregs for example, and outer layers 32, 33 comprising a high-grade fiber composite material, for example, produced from resin-impregnated fiber mattings, fiber strands, and/or carbon fibers.

In addition, or in the alternative, the layered structure, although not visible in the wound regions 17, 18, can be provided to extend along the whole length of the spring band.

In embodiments of a spring band having greater thickness of the reversal regions 12, 13 and/or the additional fiber windings 17, 18, the bending resistance moment in the reversal regions 12, 13 of the band spring can be provided to be greater than that of the intermediate portions 14, 15. Thus, if the band spring is subjected to tensile compressive loads in the direction of the longitudinal center axis L, the inner stress conditions can be provided to be more uniform.

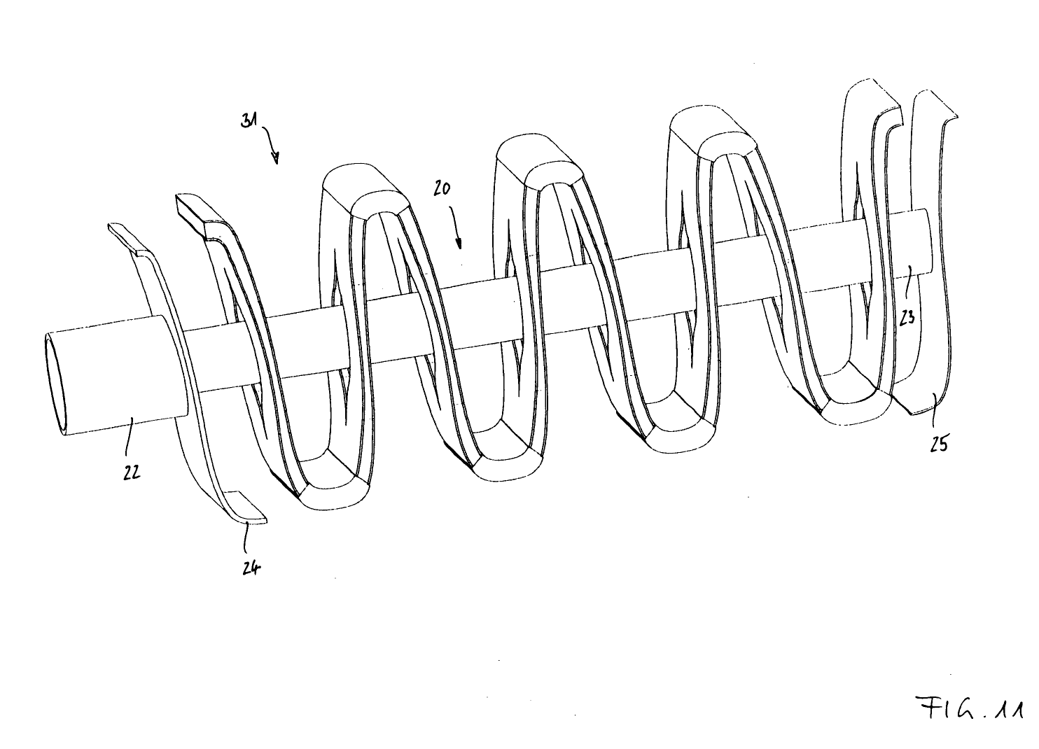

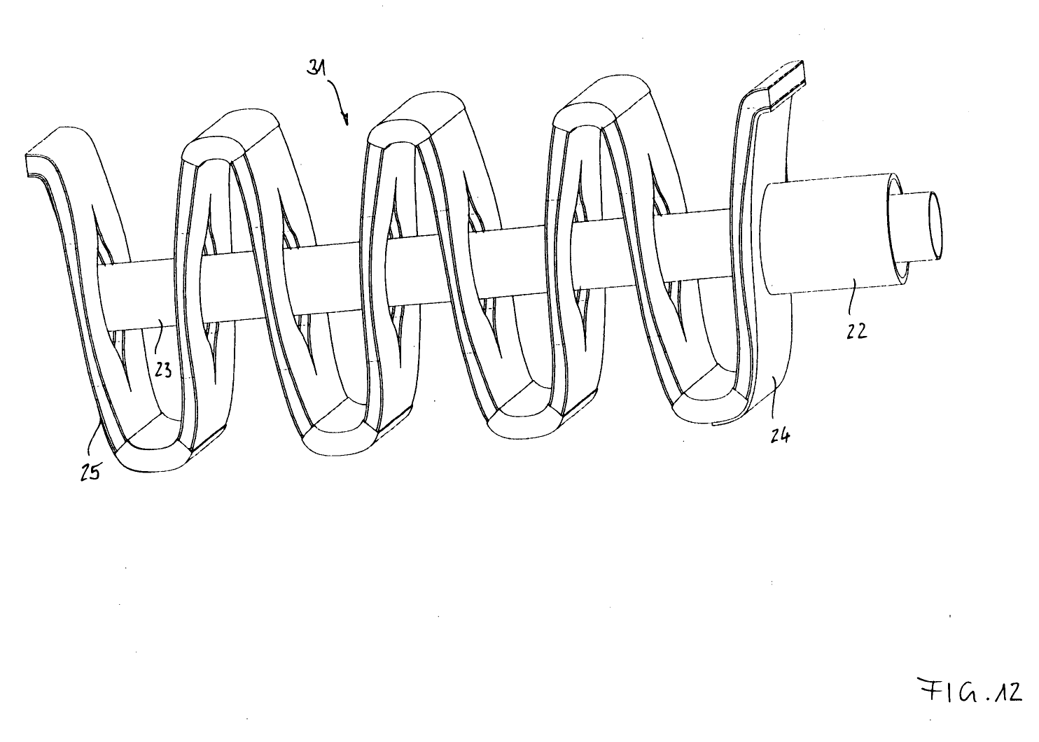

FIGS. 11 and 12 are described jointly below. They show a spring strut structure with a band spring 31 according to FIG. 10. FIG. 11 shows an exploded view in the direction of the longitudinal center line L whereas FIG. 12 shows a finish-assembled unit.

FIGS. 11 and 12 show parts of a damper unit 20 including a spring band 31 according to the invention, such as in FIG. 10, both partially mounted and finish-mounted. An outer damper tube 22 is firmly connected to a first spring plate 24 and an inner damper tube is firmly connected to a second spring plate 25. The inner damper tube can be provided to pass through the holes 16′ of the intermediate portions 14, 15. The details of the completed damper unit 20 not all being visible. More particularly, the outer damper tube 22 can be provided to extend further over the inner damper tube 23 and it can be provided to pass through part of the holes 16′. The upper and lower spring plates 24, 25 can be provided as curved band portions from plate metal and can rest in a planar way against the intermediate portions 14, 15 of the wave train of the band spring at the ends of the band spring. Accordingly, the supported intermediate portions can experience reduced bending loads. To that extent, the variation in the width and thickness of the spring band in such regions can be less important. However, the last complete reversal regions 12, 13, which project from the spring plates 24, 25, in accordance with the invention, can be provided with an increased bending moment resistance. It can be appreciated that the damper unit 20 can also guide the spring band, and prevent lateral buckling in the center plane of the wave train or in the vertical center plane because the holes 16′ are guided on the damper unit 20.

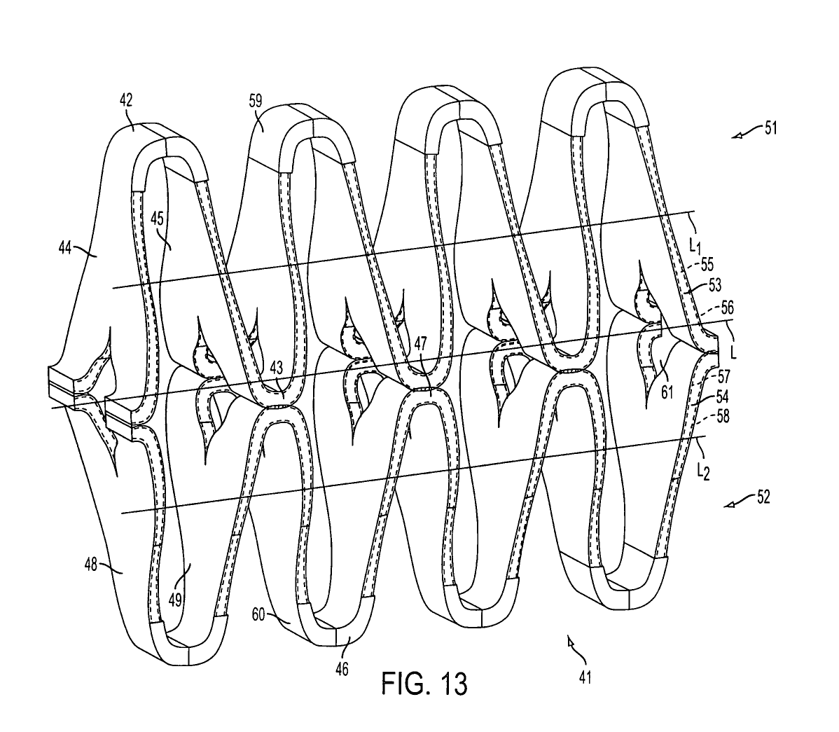

FIG. 13 shows a spring band 41 according to the invention of the second double-wave type which comprises two wave trains 51, 52 wherein the first wave train 51 is provided to meander around a first central axis L1 and the second wave train 52 is provided to meander around a second central axis L2. The axes L1, L2 can be provided to extend parallel relative to one another. For reference of describing positions, an overall longitudinal central line L can be provided which is parallel to, and centrally between, the two longitudinal central lines L1 and L2, and which can be provided to approximately corresponds to the direction of the force introduction line K. The first wave train 51 can comprise outer reversal regions 42 and inner reversal regions 43 which can be connected to one another by slightly bent intermediate portions 44, 45. The second wave train 52 can comprise outer reversal regions 46 and inner reversal regions 47 which can be connected to one another by slightly bent intermediate portions 48, 49. The width B of the wave trains can be provided to change to a lesser extent than the thickness H of the wave trains 51, 52. The thickness H can be greatest in the outer reversal regions 42, 46, and a less pronounced increase in thickness can be provided in the inner reversal regions 43, 47 relative to the intermediate portions 46, 47, 48, 49. Similarly to embodiments according to FIG. 5, the outer reversal regions 42, 46 can be reinforced by additional fiber windings 59, 60 which can provide an additional increase in the bending resistance moment. Similarly to the design of embodiments of a band spring according to FIGS. 10 to 12, the instant wave trains 51, 52 can comprise a layered structure, with a central layer 53, 54 provided having variable thickness, outer layers 55, 56, 57, 58 provided having more high-grade material and which can have a constant thickness along the length of the band spring. In this embodiment, too, the higher-grade material can be comprised of, for example, strands or woven mattings of carbon fiber, aramid fibers or metal fibers. The inner central layers 53, 54 can be comprised of prepregs of glass fiber mattings.

An important aspect of embodiment shown here is that the two wave trains 51, 52 can be connected to one another at their respective inner reversal regions 43, 47. Although two independent wave trains can be provided which are subsequently connected to one another, an alternative embodiment includes providing fiber strands of the one wave train to extend in the other wave train and vice versa in the connecting regions of the wave trains. The illustrated double-wave band spring therefore can be regarded as an integral unity

As viewed in the direction of the longitudinal central line L, approximately lens-shaped holes 61 can be provided to pass symmetrically through the inner reversal regions. The reversal regions can be widened in such a way that their effective width comes close to the effective width of the outer reversal regions 42, 43, i.e. by neglecting the through-holes, the effective width is approximately constant. The function of the through-holes 61 can be gathered from the following Figure.

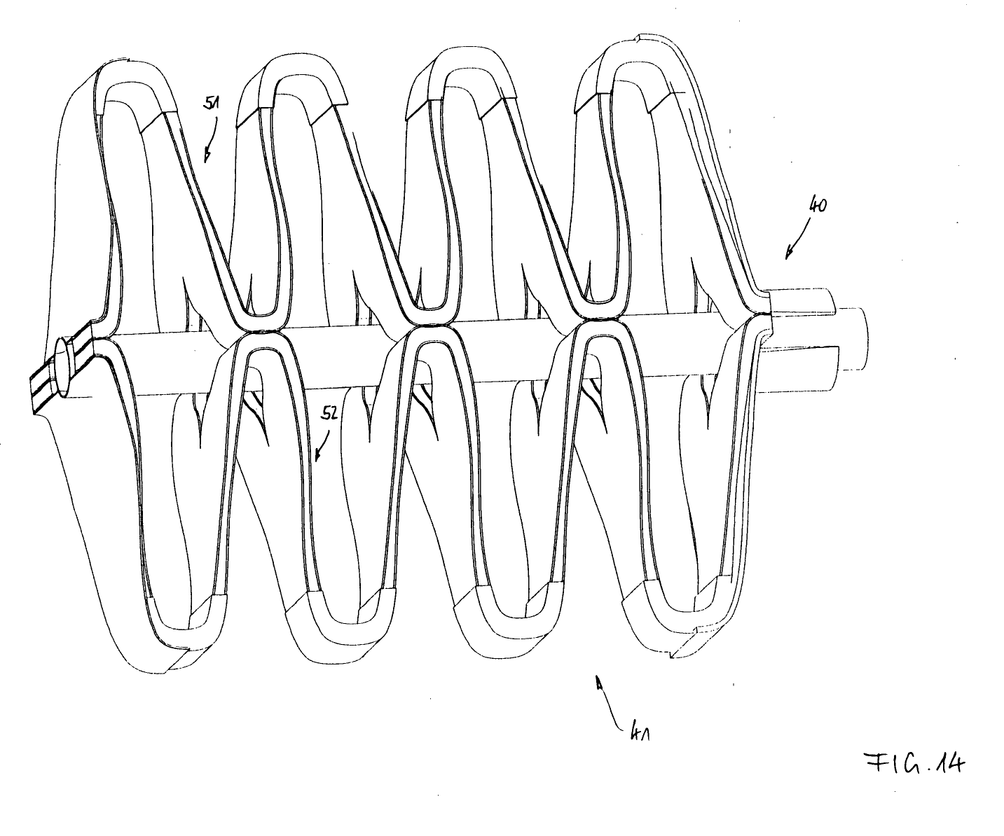

In FIG. 14, any details corresponding to those shown in FIG. 13 have been given the same reference numbers, and only several reference numbers provided for clarity. To that extent, reference is made to the preceding description. A damper unit 40 can be inserted into the aligned holes 61, with an outer damper tube 62 being connected to a lower spring plate 64, into which there can be inserted an inner damper tube 63 which can be provided with an upper spring plate 65. The spring plates 64, 65 can be curved band members from plate metal which, in a planar way, can be provided to rest against the last connecting portions of the wave trains 51 and 52, so that forces can be introduced without subjecting portions of the device to bending loads. Bending forces can act on the first outer reversal regions 42, 46 which project from the spring plates 64, 65, as well as on the entire further part of the spring. The outer reversal regions 42, 46, which can be subjected to higher loads, can be provided with an increased bending resistance moment so that the inner stresses in the spring material can be adjusted to one another and, be made approximately constant throughout.

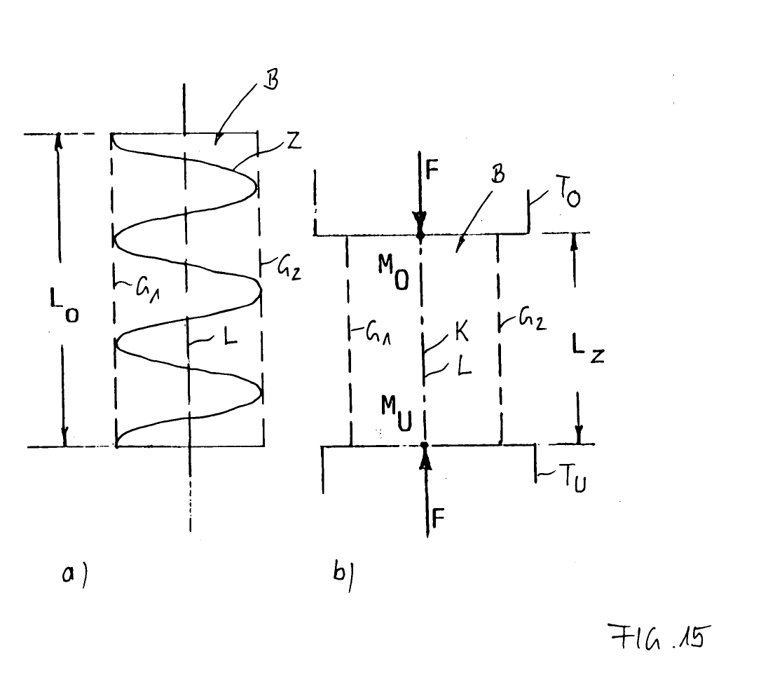

FIG. 15, in a side view, shows the principles of an embodiment of a band spring B according to the invention which can comprise a straight longitudinal center line L. A wave train Z can be provided between two delimiting lines G₁, G₂ in a stress-relieved condition with the length L0.

In illustration b) the shortened band spring B is shown having parallel delimiting lines G₁, G₂, wherein the band spring, under the effect of opposed forces F between two parallel spring parts TO, TU can become shortened to the length LZ. The forces F can act in the direction of a force introduction line K which extends between an upper winding center MO and a lower winding center MU of the band spring B.

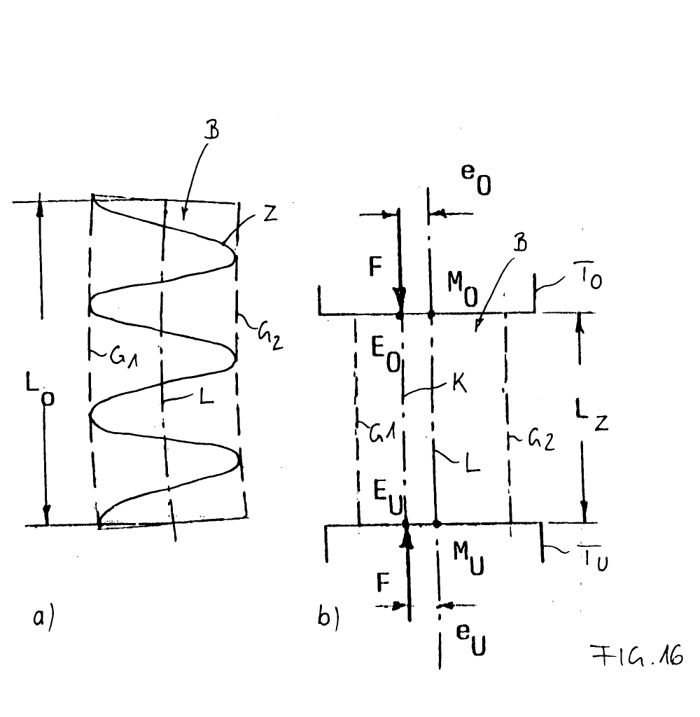

FIG. 16 shows design aspects of a band spring B according to the invention in a side view, which band spring B can comprise a C-shaped curved longitudinal center line L. Illustration a) shows the wave train Z between two C-shaped curved delimiting lines G₁, G₂ in a stress-relieved condition with the length L0.

In illustration b), the shortened band spring B is shown having the now parallel straight limiting lines G₁, G₂ wherein the band spring, under the effect of opposed forces F between two parallel spring plates TO, TU can become shortened to the length LZ. The forces F act in the direction of a force introduction line K which, relative to an upper winding center MO and a lower winding center MU of the band spring can comprise a lateral offset eo, eu acting in the same direction and of identical size, so that the force introduction like K can become offset in parallel relative to the longitudinal center line L.

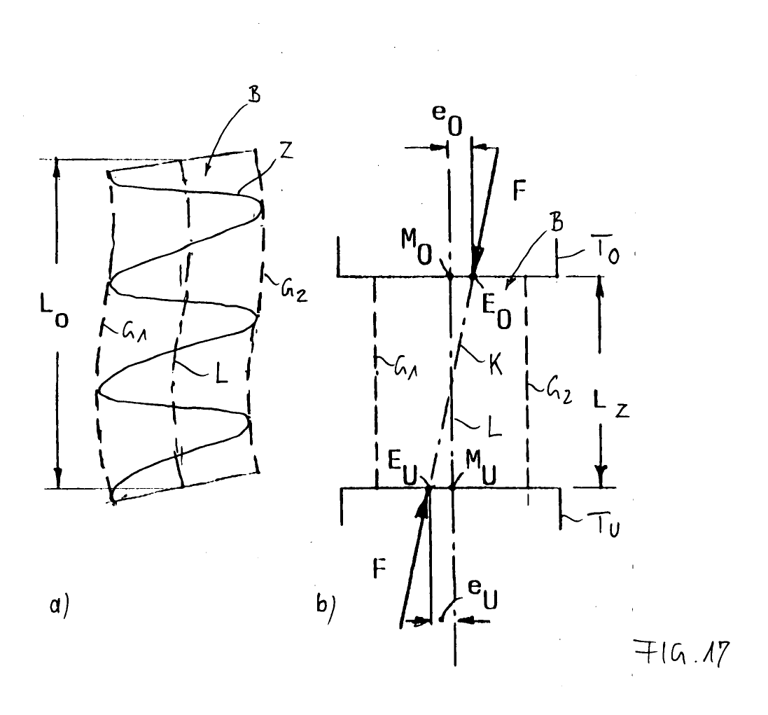

FIG. 17 shows design aspects of an inventive band spring B in a side view, which band spring B can be provided having an S-shaped curved longitudinal center line L. Illustration a) shows the wave train Z between two S-shaped curved delimiting lines G₁, G₂ in a stress-relieved condition with the length L0.

In illustration b), the shortened band spring B is shown having the now parallel straight limiting lines G₁, G₂ wherein the band spring, under the effect of opposed forces F between two parallel spring plates TO, TU, can become shortened to the length LZ. The forces F can act in the direction of a force application line K which, relative to an upper winding center MO and a lower winding center MU of the band spring, can comprise a lateral offset eo, eu acting in the same direction and of identical size, so that the force introduction like K can intersect the longitudinal center line L in its center.

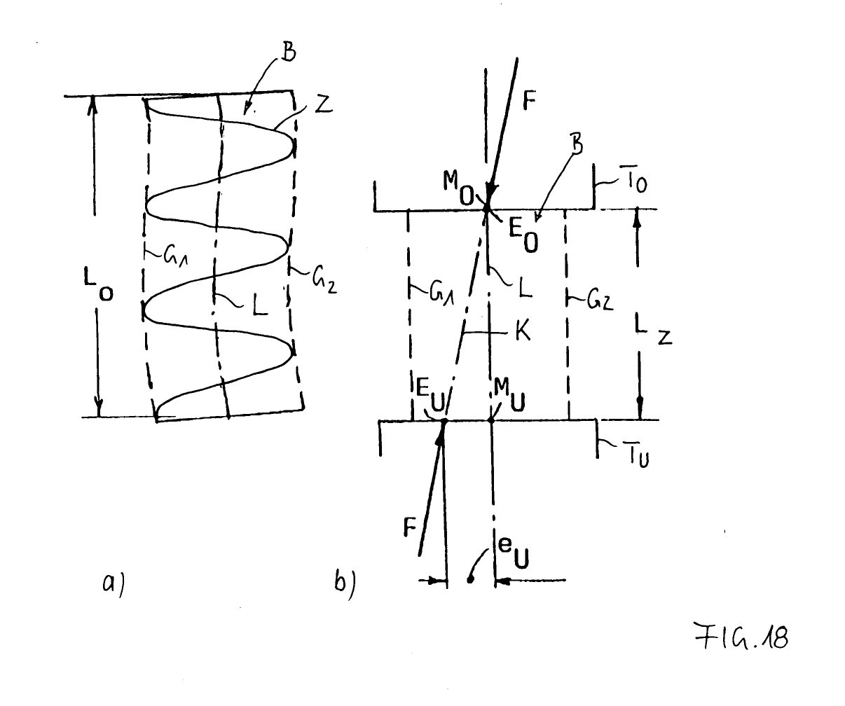

FIG. 18 shows design aspects of a band spring B according to the invention in a side view which can comprise a longitudinal center line L formed by a C-shaped curve being superimposed on an S-shaped curve. Illustration a) shows the wave train Z between two delimiting lines G₁, G₂ in a stress-relieved condition with the length L0, the curvature of which corresponds to the curvature of the longitudinal center line L.

In illustration b), the shortened band spring is shown having the now parallel straight delimiting lines G₁, G₂, wherein the band spring, under the influence of two opposed forces F between two parallel spring plates TO, TU, can become shortened to the length LZ. The forces can act in the direction of the force application line K which can extend through an upper winding center MO and which can comprise a lateral offset eu relative to a lower winding center MU of the band spring.

In this way, by modifying the shape of the spring, it is possible to achieve different spring characteristics.

1. A band spring comprising: a fiber composite material and extending in an undulating way, wherein a spring band meanders in the form of one single wave train composed of reversal regions and intermediate portions around a longitudinal center line (L) which, substantially, corresponds to the direction of force introduction (K), wherein, in the reversal regions of the wave train, there is provided an increased resistance moment of the spring band.

2. A band spring according to claim 1, wherein the width (B) of the spring band in the reversal regions is increased relative to the width of the connecting intermediate portions, wherein the width (B) of the spring band extends transversely to the curvature of the wave train.

3. A band spring according to claim 1, wherein the thickness (H) of the spring band in the reversal regions is increased relative to the thickness of the connecting intermediate portions.

4. A band spring according to claim 1, wherein the effective cross-sectional area of the spring band is substantially constant along the length of same.

5. A band spring according to claim 1, wherein the band spring consists of glass-fiber-reinforced plastics (GRP) and/or of carbon-fiber-reinforced plastics (CFRP) and/or of aramid-fiber-reinforced plastics.

6. A band spring according to claim 1, wherein, in the axis of the longitudinal center line (L), the intermediate portions comprise through-holes which are aligned relative to one another.

7. A band spring according to claim 1, wherein the spring band is produced by using cut-to-size resin-impregnated fiber mattings (prepregs).

8. A band spring according to claim 1, wherein the spring band is produced by using in-situ-laid, resin-impregnated fiber strands (rowings).

9. A band spring according to claim 1, wherein additional portions of resin-impregnated fiber mattings (prepregs) are worked into the reversal regions.

10. A band spring according to claims 1, wherein additional resin-impregnated fiber strands (rowings) are wound around the reversal regions transversely to the longitudinal extension of the spring band.

11. A band spring according to claim 1, wherein the spring band is multi-layered, wherein at least in the reversal regions, at least on the convex outside, there is worked in an additional layer of a fiber composite material of a high-grade quality.

12. A band spring according to claim 1, wherein the variation in the width (B) takes place uniformly along the length of the spring band.

13. A band spring according to claim 1, wherein the variation in the width (B) along the length of the spring band is defined by a sinusoidal shape of the longitudinal edges.

14. A band spring according to claim 1, wherein the variation in the thickness (H) along the length of the spring band is substantially uniform or finely stepped.

15. A band spring according to claim 1, wherein hat, at both ends, the spring band ends in a reversal region.

16. A band spring according to claim 1, wherein the intermediate portions are bent at most slightly, more particularly, they are planar.

17. A band spring comprising a fiber composite material and extending in the form of a double wave, wherein two spring bands meander in the form of wave trains consisting of reversal regions and intermediate portions around two center line (L1, L2) which extend parallel relative to one another and which are positioned parallel to a longitudinal center lines (L) which is positioned therebetween and which substantially corresponds to the direction of force introduction (K), wherein the spring bands are connected to one another in first inner reversal regions of the wave trains and, in the second outer reversal regions of the wave trains, comprise an increased resistance moment.

18. A band spring according to claim 17, wherein the width (B) of the spring bands in the outer reversal regions is increased relative to the width of the connecting intermediate portions, wherein the width (B) of the spring bands extends transversely to the curvature of the wave trains.

19. A band spring according to claim 17, wherein the thickness (H) of the spring bands in the outer reversal regions is increased relative to the thickness of the connecting intermediate regions.

20. A band spring according to claim 17, wherein the effective cross-sectional area of the spring bands is substantially constant along the length of same.

21. A band spring according to claim 17, wherein the band spring consists of glass-fiber-reinforced plastics (GRP) and/or of carbon-fiber-reinforced plastics (CFRP) and/or of aramid-fiber-reinforced plastics.

22. A band spring according to claim 17, wherein, in the axis of the longitudinal center line (L), the inter-connected reversal regions (43, 47) are passed through by through-holes which are aligned relative to one another.

23. A band spring according to claim 17, wherein the spring bands are produced by using cut-to-size, resin-impregnated fiber mattings (prepregs).

24. A band spring according to claim 17, wherein the spring bands are produced by in-situ-laid, resin-impregnated fiber strands (rowings).

25. A band spring according to claim 17, wherein additional portions of resin-impregnated fiber mattings (prepregs) are worked into the outer reversal regions.

26. A band spring according to claim 17, wherein additional resin-impregnated fiber strands (rowings) are wound around the outer reversal regions transversely to the longitudinal extension of the spring bands.

27. A band spring according to claim 17, wherein the spring bands are multi-layered, wherein at least one additional high-grade fiber composite material layer is worked into the outer reversal regions at least on the convex outside.

28. A band spring according to claim 17, wherein the variation in the width takes place uniformly along the length of the spring bands.

29. A band spring according to claim 17, wherein the variation in the width along the length of the spring bands is defined by a sinusoidal shape of the longitudinal edges.

30. A band spring according to claim 17, wherein the variation in the thickness along the length of the spring bands takes place substantially uniformly or in a slightly stepped way.

31. A band spring according to claim 1, wherein, at both ends, the spring bands end in a reversal region.

32. A band spring according to claim 1, wherein the intermediate portions are bent at most slightly, more particularly, they are planar.

33. A band spring according to claim 1, wherein the longitudinal center line (L) is curved so as to be C-shaped.

34. A band spring according to claim 1, wherein the longitudinal center line (L) is curved symmetrically so as to be entirely S-shaped.

35. A band spring according to claim 1, wherein the longitudinal center line (L) follows a curved course which results from a C-shaped curve and a symmetric S-shaped curve being superimposed on one another.

36. A spring strut for a motor vehicle with a band spring according to claim 1, wherein a tube-shaped damping element is passed through the through-holes of the band spring and is connected to at least one end of the band spring.

37. A spring strut according to claim 36, wherein an inner tube and/or an outer tube of the damping element are/is connected to a spring plate which rests in a planar way against an end portion of the band spring as far as the first reversal region.
